(19) United States
(12) Patent Application Publication
(10) Pub. No.: US 2013/0265215 A1
(43) Pub. Date: Oct. 10, 2013

(54) LIGHT-EMITTING COMPONENT DRIVING CIRCUIT AND RELATED PIXEL CIRCUIT

(71) Applicants: Wen-Tui Liao, Taichung City (TW); Pei-Yuan Chang, Taichung City (TW); Ying-Ching Tseng, Taichung City (TW); Jing-Wen Yin, Guangdong Province (CN)

(72) Inventors: Wen-Tui Liao, Taichung City (TW); Pei-Yuan Chang, Taichung City (TW); Ying-Ching Tseng, Taichung City (TW); Jing-Wen Yin, Guangdong Province (CN)

(73) Assignees: WINTEK CORPORATION, Taichung City (TW); DONGGUAN MASSTOP LIQUID CRYSTAL DISPLAY CO., LTD., Guangdong Province (CN)

(21) Appl. No.: 13/859,753

(22) Filed: Apr. 10, 2013

(30) Foreign Application Priority Data
Apr. 10, 2012 (CN) 201210104074.0

(51) Int. Cl. G09G 3/32

(52) U.S. Cl. CPC G09G 3/3208
USPC 345/82

(57) ABSTRACT

A pixel circuit relating to an organic light emitting diode (OLED) is provided by the invention, and if the circuit configuration (5T1C) thereof collocates with suitable operation waveforms, the current flowing through an OLED in the OLED pixel circuit is not varied along with the variation of the conducting voltage (Voled_th) of the OLED in a long time driving current stress, and is not varied with the threshold voltage (Vth) shift of a TFT used for driving the OLED. Accordingly, not only the brightness decay of the OLED in the long time stress is mitigated or compensated, but also the brightness uniformity of the applied OLED display is substantially improved.

### CROSS-REFERENCE TO RELATED APPLICATION

This application claims the priority benefit of China application serial no. 201210104074.0, filed on Apr. 10, 2012. The entirety of the above-mentioned patent application is hereby incorporated by reference herein and made a part of this specification.

### BACKGROUND OF THE INVENTION

1. Field of the Invention

The invention relates to a flat panel display technique. Particularly, the invention relates to a driving circuit of a light-emitting component having a self-luminous characteristic (for example, an organic light-emitting diode) and a related pixel circuit.

2. Description of Related Art

Along with rapid development of multimedia society, techniques in semiconductor components and display devices are also quickly developed. Regarding the display devices, since an active matrix organic light-emitting diode (AMOLED) display has advantages of without viewing-angle limitation, low manufacturing cost, a high response speed (approximately a hundred times faster than that of a liquid crystal display (LCD)), power saving, self-luminous, direct current (DC) driving suitable for portable applications, a large range of operating temperature, light weight and capable of being miniaturized and thinned along with hardware equipment, etc, it complies with a display requirement of a multimedia age. Therefore, the AMOLED display has a great development potential to become a novel flat panel display of a next generation, and can be used to replace the LCD.

Presently, there are two methods to fabricate an AMOLED display panel, one method is to fabricate by using a low temperature polysilicon (LTPS) thin-film transistor (TFT) process technique, and another method is to fabricate by using an a-Si TFT process technique. Since the LTPS TFT process technique requires more optical mask processes, a fabrication cost thereof is increased. Therefore, the current LTPS TFT process technique is mainly adapted to middle or small size panels, and the a-Si TFT process technique is mainly adapted to large size panels.

Generally, regarding the AMOLED display panel fabricated by the LTPS TFT process technique, a pattern of TFT(s) in a pixel circuit thereof can be P type or N type, however, regardless of implementing an OLED pixel circuit through the P-type or the N-type TFT(s), a current flowing through OLED is not only varied along with a variation of a conducting voltage (Voled_th) of the OLED in a long time stress, but is also varied along with a threshold voltage (Vth) shift of the TFT used for driving the OLED. Therefore, brightness uniformity and brightness constancy of the OLED display is influenced.

### SUMMARY OF THE INVENTION

Accordingly, in order to effectively resolve/ameliorate the problem of the related art (i.e. to improve brightness uniformity and brightness constancy of an organic light-emitting diode (OLED) display), an exemplary embodiment of the invention provides a light-emitting component driving circuit including a driving unit and a data storage unit. The driving unit is coupled between a preset potential and a light-emitting component (for example, an OLED, though the invention is not limited thereto), and includes a driving transistor, which is configured to control a driving current flowing through the light-emitting component in an emission phase. The data storage unit includes a storage capacitor directly coupled to a conduction path used for conducting the driving current, which is configured to store a data voltage, a threshold voltage related to the driving transistor and a conducting voltage related to the light-emitting component through the storage capacitor in a data-writing phase. In the emission phase, the driving unit generates the driving current flowing through the light-emitting component in response to a cross-voltage of the storage capacitor, and the driving current is not influenced by the threshold voltage of the driving transistor and the conducting voltage of the light-emitting component.

In an exemplary embodiment of the invention, in case that the preset potential is a ground potential, the driving unit further includes an emission control transistor, where a gate thereof receives an emission signal, a source thereof is coupled to the ground potential, and a drain thereof is coupled to a source of the driving transistor and a first end of the storage capacitor. Moreover, a drain of the driving transistor is coupled to a cathode of the OLED, and an anode of the OLED is coupled to a power voltage.

In an exemplary embodiment of the invention, in case that the preset potential is the ground potential, the data storage unit further includes a writing transistor, a collection transistor and a transformation transistor. A gate of the writing transistor receives a scan signal, a drain of the writing transistor receives the data voltage, and a source of the writing transistor is coupled to a second end of the storage capacitor. A gate of the collection transistor receives the scan signal, a source of the collection transistor is coupled to a gate of the driving transistor, and a drain of the collection transistor is coupled to the drain of the driving transistor and the cathode of the OLED. A gate of the transformation transistor receives the emission signal, a source of the transformation transistor is coupled to the gate of the driving transistor and the source of the collection transistor, and a drain of the transformation transistor is coupled to the source of the writing transistor and the second end of the storage capacitor.

In an exemplary embodiment of the invention, in case that the preset potential is the ground potential, the OLED driving circuit sequentially operates the data-writing phase and the emission phase.

In an exemplary embodiment of the invention, in case that the preset potential is the ground potential, the driving transistor, the emission control transistor, the writing transistor, the collection transistor and the transformation transistor are all N-type transistors.

In an exemplary embodiment of the invention, in case that the preset potential is the ground potential, in the data-writing phase, only the scan signal is enabled, and in the emission phase, only the emission signal is enabled.

In an exemplary embodiment of the invention, in case that the preset potential is a power voltage, the driving unit further includes an emission control transistor, where a gate thereof receives an emission signal, a source thereof is coupled to the power voltage, and a drain thereof is coupled to a source of the driving transistor and a first end of the storage capacitor. Moreover, a drain of the driving transistor is coupled to an anode of the OLED, and a cathode of the OLED is coupled to a ground potential.

In an exemplary embodiment of the invention, in case that the preset potential is the power voltage, the data storage unit further includes a writing transistor, a collection transistor and a transformation transistor. A gate of the writing transistor receives a scan signal, a source of the writing transistor receives the data voltage, and a drain of the writing transistor is coupled to a second end of the storage capacitor. A gate of the collection transistor receives the scan signal, a drain of the collection transistor is coupled to a gate of the driving transistor, and a source of the collection transistor is coupled to the drain of the driving transistor and the anode of the OLED. A gate of the transformation transistor receives the emission signal, a drain of the transformation transistor is coupled to the gate of the driving transistor and the source of the collection transistor, and a source of the transformation transistor is coupled to the drain of the writing transistor and the second end of the storage capacitor.

In an exemplary embodiment of the invention, in case that the preset potential is the power voltage, the storage capacitor is reset in a reset phase in response to the power voltage and the data voltage.

In an exemplary embodiment of the invention, in case that the preset potential is the power voltage, the OLED driving circuit sequentially operates the reset phase, the data-writing phase and the emission phase.

In an exemplary embodiment of the invention, in case that the preset potential is the power voltage, the driving transistor, the emission control transistor, the writing transistor, the collection transistor and the transformation transistor are all P-type transistors.

In an exemplary embodiment of the invention, in case that the preset potential is the power voltage, in the reset phase, the scan signal and the emission signal are simultaneously enabled, in the data-writing phase, only the scan signal is enabled, and in the emission phase, only the emission signal is enabled.

In an exemplary embodiment of the invention, the power voltage is a fixed power voltage.

In another exemplary embodiment of the invention, the power voltage is a variable power voltage. In this case, the power voltage is changed from a high level voltage to a setting voltage only in the data-writing phase (in case that the present potential is the ground potential) or the reset phase (in case that the present potential is the power voltage). The setting voltage is lower than the high level voltage, and the setting voltage is determined according to the threshold voltage of the driving transistor and the conducting voltage of the OLED.

In an exemplary embodiment of the invention, the light-emitting component driving circuit is an OLED driving circuit.

Another exemplary embodiment of the invention provides a pixel circuit having the light-emitting component driving circuit.

According to the above descriptions, the invention provides a pixel circuit related to an OLED, and if a circuit configuration (5T1C) thereof collocates with suitable operation waveforms, a current flowing through the OLED is not varied along with a variation of a conducting voltage (Voled_th) of the OLED in a long time stress, and is not varied along with the threshold voltage (Vth) shift of a TFT used for driving the OLED. Accordingly, not only the brightness decay of the OLED in a long time stress can be mitigated or compensated, but also the brightness uniformity of the applied OLED display can be substantially improved.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a pixel circuit 10 according to an exemplary embodiment of the invention.

FIG. 2 is an implementation circuit diagram of the pixel circuit 10 of FIG. 1.

FIG. 3 is an operation waveform diagram of the pixel circuit 10 of FIG. 1.

FIG. 4A and FIG. 4B are operation schematic diagrams of the pixel circuit 10 of FIG. 1.

FIG. 5 is another operation waveform diagram of the pixel circuit 10 of FIG. 1.

FIG. 6 is a schematic diagram of a pixel circuit 60 according to another exemplary embodiment of the invention.

FIG. 7 is an implementation circuit diagram of the pixel circuit 60 of FIG. 6.

FIG. 8 is an operation waveform diagram of the pixel circuit 60 of FIG. 6.

FIG. 9A-9C are operation schematic diagrams of the pixel circuit 60 of FIG. 6.

FIG. 10 is another operation waveform diagram of the pixel circuit 60 of FIG. 6.

### DETAILED DESCRIPTION OF DISCLOSED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

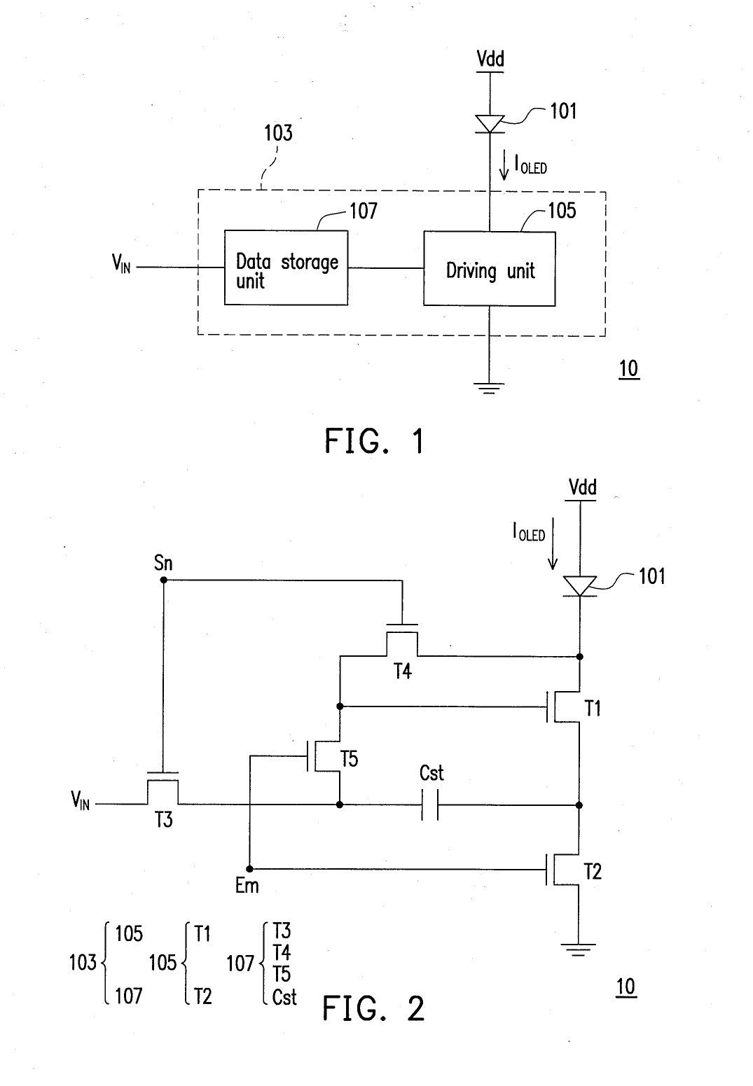

FIG. 1 is a schematic diagram of a pixel circuit 10 according to an exemplary embodiment of the invention, and FIG. 2 is an implementation circuit diagram of the pixel circuit 10 of FIG. 1. Referring to FIG. 1 and FIG. 2, the pixel circuit 10 of the present exemplary embodiment includes a light-emitting component (for example, an organic light-emitting diode (OLED) 101, though the invention is not limited thereto, and the pixel circuit 10 can be regarded as an OLED pixel circuit) and a light-emitting component driving circuit 103. The light-emitting component driving circuit 103 includes a driving unit 105 and a data storage unit 107.

In the present exemplary embodiment, the driving unit 105 is coupled between a present potential (for example, a ground potential) and the OLED 101, and includes a driving transistor T1 for controlling a driving current I_{OLED} flowing through the OLED 101 in an emission phase.

The data storage unit 107 includes a storage capacitor Cst directly coupled to a conduction path used for conducting the driving current I_{OLED}, which is configured to store a data voltage V_{IN}, a threshold voltage Vₜₕ(T1) related to the driving transistor T1 and a conducting voltage (Voled_th) related to the OLED 101 through the storage capacitor Cst in a data-writing phase.

In the present exemplary embodiment, in the emission phase, the driving unit 105 generates the driving current I_{OLED} flowing through the OLED 101 in response to a voltage across the storage capacitor Cst, and the driving current I_{OLED} is not influenced by the threshold voltage Vₜₕ(T1) of the driving transistor T1 and the conducting voltage (Voled_th) of the OLED 101. In other words, the driving current I_{OLED} is non-related to the conducting voltage (Voled_th) of the OLED 101 and the threshold voltage Vₜₕ(T1) of the driving transistor T1.

Besides, the driving unit 105 further includes an emission control transistor T2. Moreover, the data storage unit 107 further includes a writing transistor T3, a collection transistor T4 and a transformation transistor T5.

In the present exemplary embodiment, the driving transistor T1, the emission control transistor T2, the writing transistor T3, the collection transistor T4 and the transformation transistor T5 are all N-type transistors, for example, N-type thin-film-transistors (TFTs). Moreover, an OLED display panel using the (OLED) pixel circuit 10 can be fabricated by using a low temperature polysilicon (LTPS) thin-film transistor (TFT) process technique, though the invention is not limited thereto.

Moreover, in a circuit configuration of the (OLED) pixel circuit 10, an anode of the OLED 101 is coupled to a power voltage Vdd, and a cathode of the OLED 101 is coupled to a drain of the driving transistor T1. A gate of the emission control transistor T2 receives an emission signal Em, a source of the emission control transistor T2 is coupled to the ground potential, and a drain of the emission control transistor T2 is coupled to a source of the driving transistor T1 and a first end of the storage capacitor Cst.

A gate of the writing transistor T3 receives a scan signal Sn, a drain of the writing transistor T3 receives the data voltage V_{IN} (assuming V_{IN}=Vdd+Vdata−Voled_in, where Voled_in is an initial conducting voltage of the OLED 101 before a long time driving current stress), and a source of the writing transistor T3 is coupled to a second end of the storage capacitor Cst. A gate of the collection transistor T4 receives the scan signal Sn, a source of the collection transistor T4 is coupled to the gate of the driving transistor T1, and a drain of the collection transistor T4 is coupled to the drain of the driving transistor T1 and the cathode of the OLED 101. A gate of the transformation transistor T5 receives the emission signal Em, a source of the transformation transistor T5 is coupled to the gate of the driving transistor T1 and the source of the collection transistor T4, and a drain of the transformation transistor T5 is coupled to the source of the writing transistor T3 and the second end of the storage capacitor Cst.

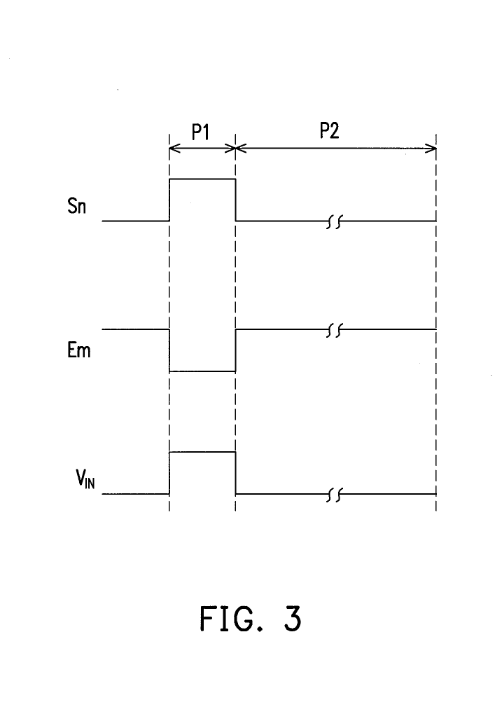

In addition, in an operation process of the (OLED) pixel circuit 10, the light-emitting component driving circuit 103 (i.e. the OLED driving circuit) sequentially operates the data-writing phase and the emission phase, which are respectively shown as phases P1 and P2 of FIG. 3. According to FIG. 3, in the data writing phase P1, only the scan signal Sn is enabled. Moreover, in the emission phase P2, only the emission signal Em is enabled.

It should be noticed that since the driving transistor T1, the emission control transistor T2, the writing transistor T3, the collection transistor T4 and the transformation transistor T5 in the (OLED) pixel circuit 10 are all N-type transistors, the driving transistor T1, the emission control transistor T2, the writing transistor T3, the collection transistor T4 and the transformation transistor T5 will be enabled at high level. Therefore, enabling of the scan signal Sn and the emission signal Em presents that the scan signal Sn and the emission signal Em are at a high level.

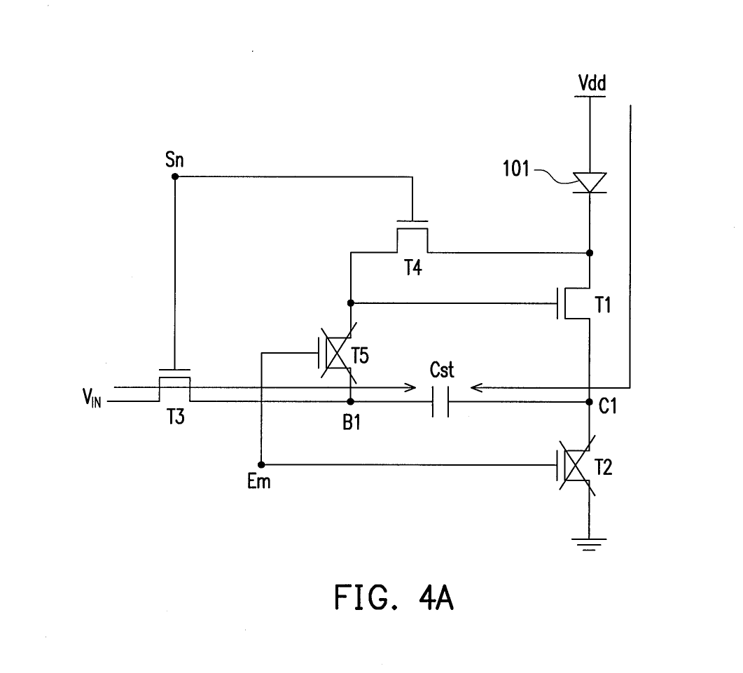

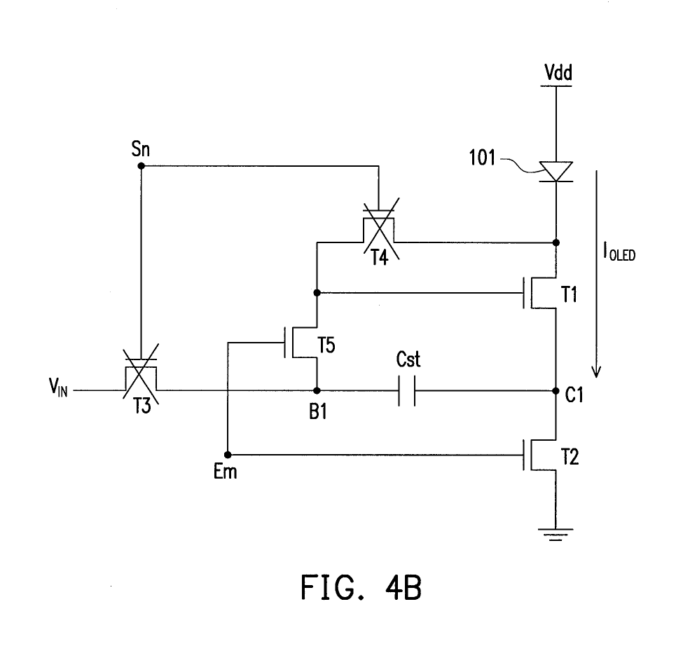

First, in the data-writing phase P1, since only the scan signal Sn is enabled, as shown in FIG. 4A, the writing transistor T3 and the collection transistor T4 are turned on (which are not marked by the symbol “X”), and the emission control transistor T2 and the transformation transistor T5 are turned off (which are marked by the symbol “X”). In this way, the driving transistor T1 represents a diode-connection in response to a turn-on state of the collection transistor T4, so as to charge the storage capacitor Cst until a voltage of a node C1 is changed to Vdd-Voled_th−Vₜₕ(T1). Moreover, in response to the turn-on state of the writing transistor T3, a voltage of the node B1 is Vdd+Vdata−Voled_in.

In the present exemplary embodiment, in the data-writing phase P1, since voltages at two ends of the OLED 101 is not greater than the conducting voltage (Voled_th) thereof, and the voltage at the node B1 is greater than the voltage at the node C1, the OLED 101 will not be lighted (due to lack of a complete current loop). On the other hand, in the data-writing phase P1, the voltage at two ends of the storage capacitor Cst can be represented as:

Vdata+Voled_th−Voled_in_Vₜₕ(T1).

Moreover, the above expression can be further simplified into Vdata+ΔVoled+Vₜₕ(T1), where ΔVoled=Voled_th−Voled_in.

Therefore, in the data-writing phase P1, the data voltage V_{IN}, the threshold voltage Vₜₕ(T1) related to the driving transistor T1 and a variation ΔVoled related to the voltage across the OLED 101 are simultaneously and completely stored by the storage capacitor Cst.

Then, in the emission phase P2, since only the emission signal Em is enabled, as shown in FIG. 4B, the writing transistor T3 and the collection transistor T4 are turned off (which are marked by the symbol “X”), and the emission control transistor T2 and the transformation transistor T5 are turned on (which are not marked by the symbol “X”). In this way, the driving transistor T1 generates the driving current I_{OLED} that is not influenced by the conducting voltage (Voled_th) of the OLED 101 and the threshold voltage Vₜₕ(T1) of the driving transistor T1.

In detail, in response to a capacitance coupling effect of the storage capacitor Cst, a gate-source voltage Vgs of the driving transistor T1 is equal to Vdata+ΔVoled+Vₜₕ(T1). In this way, in the emission phase P2, the driving current I_{OLED} generated by the driving transistor T1 can be represented by a following equation 1:

$${I}_{OLED} = \frac{1}{2} K \times {( Vgs - {V}_{th} ( T 1 ) )}^{2} , \qquad 1$$

where K is a current constant related to the driving transistor T1.

In addition, since the gate-source voltage Vgs of the driving transistor T1 is already known, i.e.: Vgs=Vdata+ΔVoled+Vₜₕ(T1), if the known gate-source voltage Vgs of the driving transistor T1 is introduced to the equation 1, a following equation 2 is obtained:

$${I}_{OLED} = \frac{1}{2} K \times {[ Vdata + Δ Voled + {V}_{th} ( T 1 ) - {V}_{th} ( T 1 ) ]}^{2} , \qquad 2$$

and the equation 2 can be further simplified into a following equation 3:

$${I}_{OLED} = \frac{1}{2} K \times {( Vdata + Δ Voled )}^{2} . \qquad 3$$

According to the equation 3, it is known that in the emission phase P2, the driving current I_{OLED} flowing through the OLED 101 is non-related to the threshold voltage Vₜₕ(T1) of the driving transistor T1. Moreover, according to the equation 3, it is known that the driving current I_{OLED} flowing through the OLED 101 is determined by Vdata and an additional parameter ΔVoled, where the additional parameter ΔVoled can be used to compensate/mitigate a brightness decay of the OLED 101 in a long time driving current stress. In this way, the driving current I_{OLED} flowing through the OLED 101 is not varied along with a variation of the conducting voltage (Voled_th) of the OLED 101 in the long time driving current stress.

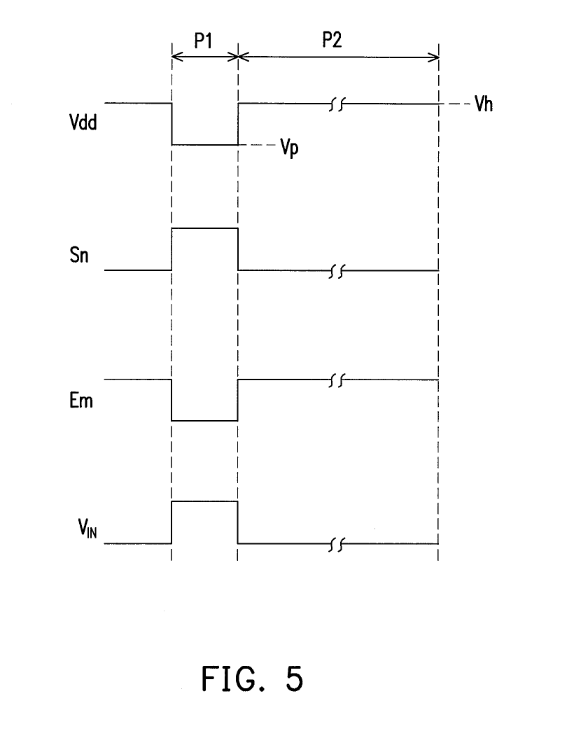

On the other hand, different to the operation waveform diagram of the (OLED) pixel circuit 10 of FIG. 3, FIG. 5 is another operation waveform diagram of the (OLED) pixel circuit 10 of FIG. 1. The operation waveform diagram of the (OLED) pixel circuit 10 of FIG. 3 is constructed based on a situation that the power voltage Vdd is a fixed power voltage, i.e. the power voltage Vdd is maintained to a high level voltage Vh.

However, the operation waveform diagram of the (OLED) pixel circuit 10 of FIG. 5 is constructed based on a situation that the power voltage Vdd is a variable power voltage, and the power voltage Vdd is changed from the high level voltage Vh to a predetermined setting voltage Vp only in the data-writing phase P1. The setting voltage Vp is lower than the high level voltage Vh, and the setting voltage Vp is determined according to the threshold voltage Vₜₕ(T1) of the driving transistor T1 and the conducting voltage (Voled_th) of the OLED 101. In other words, the setting voltage Vp can be a voltage just capable of conducting the OLED 101 and the driving transistor T1, for example, Voled_th+Vₜₕ(T1), though the invention is not limited thereto.

A difference between the operation waveform diagrams of the (OLED) pixel circuit 10 of FIG. 3 and FIG. 5 is that as the power voltage Vdd of FIG. 5 can be changed from the high level voltage Vh to the setting voltage Vp in the data-writing phase P1, the voltage of the node C1 is changed (decreased) to Vp−Voled_th−Vₜₕ(T1), and the voltage of the node B1 is changed (decreased) to Vp+Vdata−Voled_in. However, according to the operation waveform diagram of the (OLED) pixel circuit 10 of FIG. 5, the driving current I_{OLED} flowing through the OLED 101 is still non-related to the threshold voltage Vₜₕ(T1) of the driving transistor T1, and meanwhile the brightness decay of the OLED 101 in the long time stress can be compensated/mitigated.

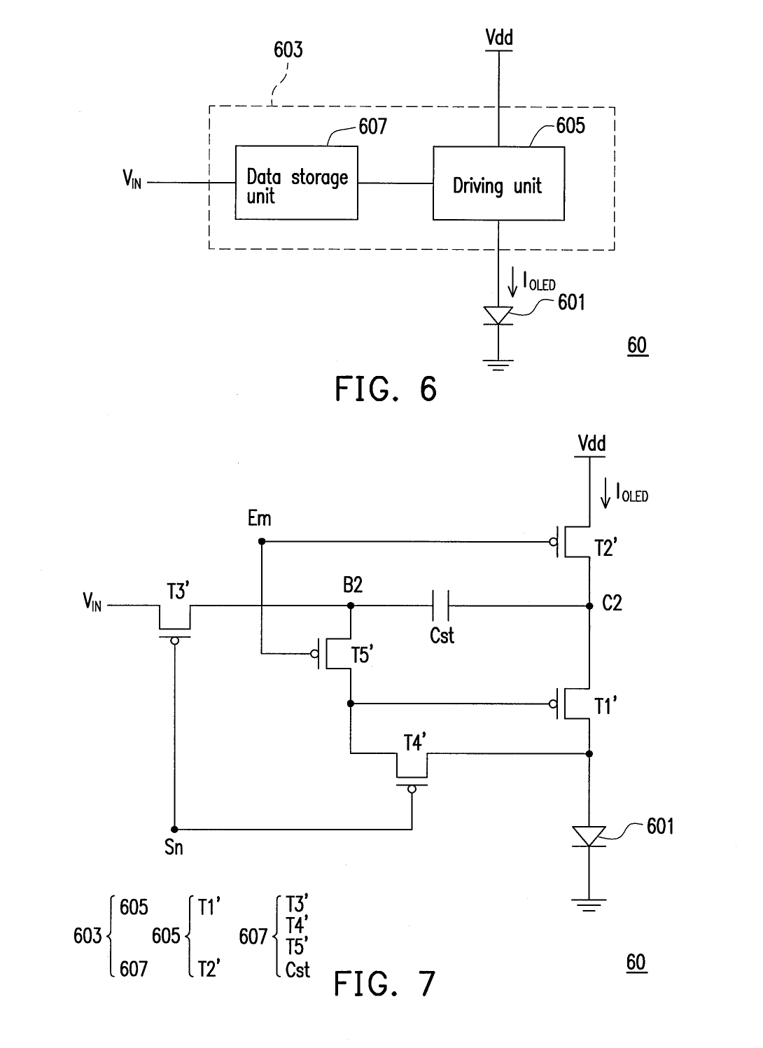

On the other hand, according to the concept similar to that of FIG. 1 and FIG. 2 (i.e. a complementary circuit configuration), FIG. 6 is a schematic diagram of a pixel circuit 60 according to another exemplary embodiment of the invention, and FIG. 7 is an implementation circuit diagram of the pixel circuit 60 of FIG. 6. Referring to FIG. 6 and FIG. 7, the pixel circuit 60 of the present exemplary embodiment includes a light-emitting component (for example, an organic light-emitting diode (OLED) 601, though the invention is not limited thereto, and the pixel circuit 60 can be regarded as an OLED pixel circuit) and a light-emitting component driving circuit 603. The light-emitting component driving circuit 603 includes a driving unit 605 and a data storage unit 607.

In the present exemplary embodiment, the driving unit 605 is coupled between a present potential (for example, a power voltage Vdd) and the OLED 601, and includes a driving transistor T1′ for controlling a driving current I_{OLED} flowing through the OLED 601 in an emission phase. Moreover, the data storage unit 607 includes the storage capacitor Cst directly coupled to a conduction path used for conducting the driving current I_{OLED}, which is configured to store the data voltage V_{IN}, a threshold voltage Vₜₕ(T1′) related to the driving transistor T1′ and the conducting voltage (Voled_th) related to the OLED 601 through the storage capacitor Cst in a data-writing phase.

In the present exemplary embodiment, in the emission phase, the driving unit 605 generates the driving current I_{OLED} flowing through the OLED 601 in response to a voltage across the storage capacitor Cst, and the driving current I_{OLED} is not influenced by the threshold voltage Vₜₕ(T1′) of the driving transistor T1′ and the conducting voltage (Voled_th) of the OLED 601. In other words, the driving current I_{OLED} is non-related to the conducting voltage (Voled_th) of the OLED 601 and the threshold voltage Vₜₕ(T1′) of the driving transistor T1′.

Besides, the driving unit 605 further includes an emission control transistor T2′. Moreover, the data storage unit 607 further includes a writing transistor T3′, a collection transistor T4′ and a transformation transistor T5′. In the present exemplary embodiment, the driving transistor T1′, the emission control transistor T2′, the writing transistor T3′, the collection transistor T4′ and the transformation transistor T5′ are all P-type transistors, for example, P-type TFTs. Moreover, an OLED display panel using the (OLED) pixel circuit 60 can be fabricated by using a LTPS TFT process technique, though the invention is not limited thereto.

Moreover, in a circuit configuration of the (OLED) pixel circuit 60, a cathode of the OLED 601 is coupled to the ground potential, and an anode of the OLED 601 is coupled to a drain of the driving transistor T1′. A gate of the emission control transistor T2′ receives an emission signal Em, a source of the emission control transistor T2′ is coupled to the power voltage Vdd, and a drain of the emission control transistor T2′ is coupled to a source of the driving transistor T1′ and the first end of the storage capacitor Cst.

A gate of the writing transistor T3′ receives a scan signal Sn, a source of the writing transistor T3′ receives the data voltage V_{IN} (assuming V_{IN}=Voled_in−Vdata, where Voled_in is an initial conducting voltage of the OLED 601 before a long time stress), and a drain of the writing transistor T3′ is coupled to the second end of the storage capacitor Cst. A gate of the collection transistor T4′ receives the scan signal Sn, a drain of the collection transistor T4′ is coupled to the gate of the driving transistor T1′, and a source of the collection transistor T4′ is coupled to the drain of the driving transistor T1′ and the anode of the OLED 601. A gate of the transformation transistor T5′ receives the emission signal Em, a drain of the transformation transistor T5′ is coupled to the gate of the driving transistor T1′ and the drain of the collection transistor T4′, and a source of the transformation transistor T5′ is coupled to the drain of the writing transistor T3′ and the second end of the storage capacitor Cst.

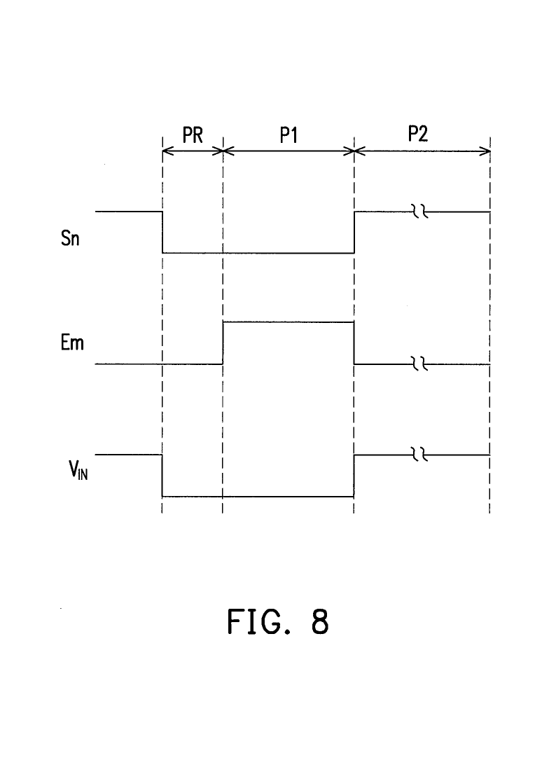

In addition, in an operation process of the (OLED) pixel circuit 60, the light-emitting component driving circuit 603 (i.e. the OLED driving circuit) sequentially operates a reset phase, the data-writing phase and the emission phase, which are respectively shown as phases PR, P1 and P2 of FIG. 8. According to FIG. 8, in the reset phase PR, the scan signal Sn and the emission signal Em are simultaneously enabled. In the data writing phase P1, only the scan signal Sn is enabled. Moreover, in the emission phase P2, only the emission signal Em is enabled.

It should be noticed that since the driving transistor T1′, the emission control transistor T2′, the writing transistor T3′, the collection transistor T4′ and the transformation transistor T5′ in the (OLED) pixel circuit 60 are all P-type transistors, the driving transistor T1′, the emission control transistor T2′, the writing transistor T3′, the collection transistor T4′ and the transformation transistor T5′ will be all enabled at a low level. Therefore, enabling of the scan signal Sn and the emission signal Em presents that the scan signal Sn and the emission signal Em are in a low level.

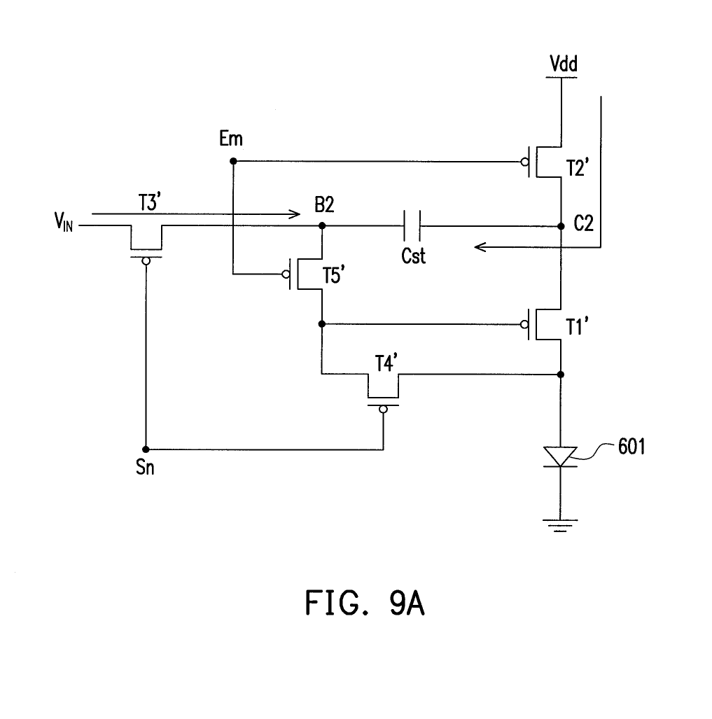

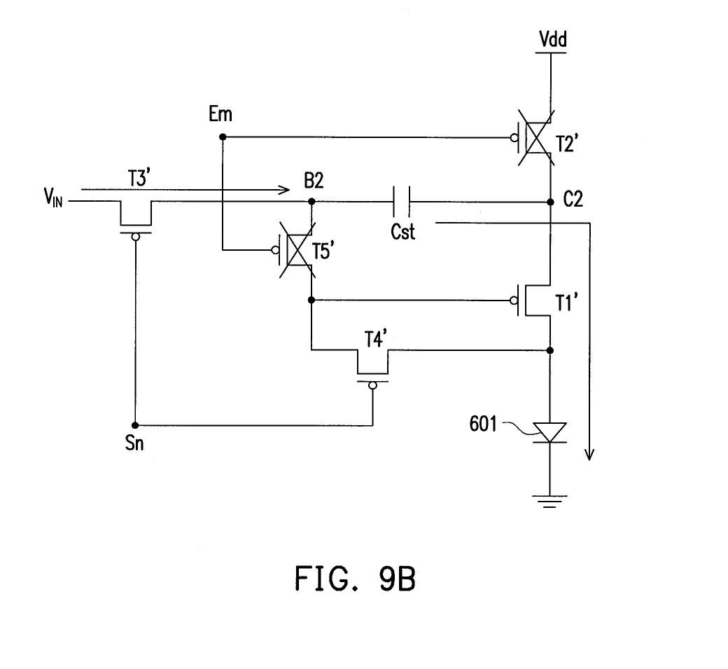

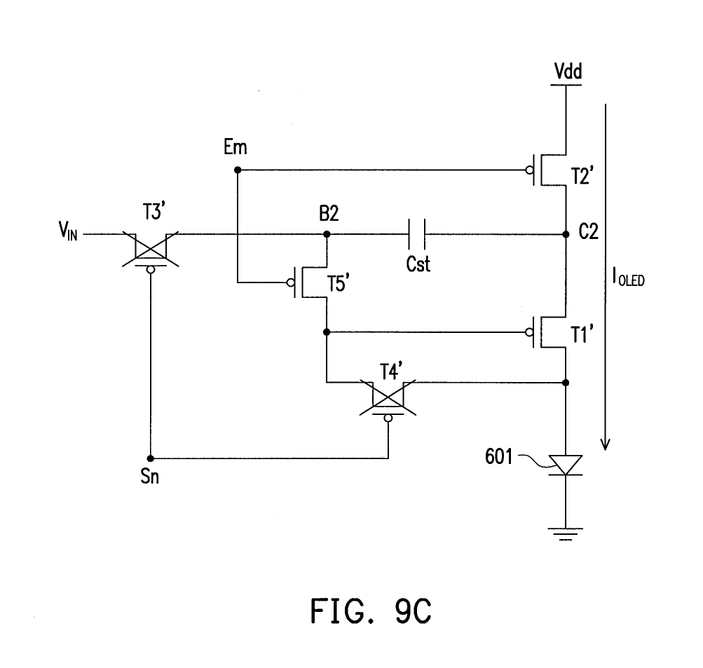

First, in the reset phase PR, since the scan signal Sn and the emission signal Em are simultaneously enabled, as shown in FIG. 9A, the emission control transistor T2′, the writing transistor T3′, the collection transistor T4′ and the transformation transistor T5′ are all turned on (which are not marked by the symbol “X”). In this way, the storage capacitor Cst is reset in the reset phase PR in response to the power voltage Vdd and the data voltage V_{IN}. In detail, in response to the turn-on state of the emission control transistor T2′, a voltage of a node C2 is substantially (or pre-charged to) the power voltage Vdd. Moreover, in response to the turn-on state of the writing transistor T3′, a voltage of a node B2 is substantially (or pre-charged to) the data voltage V_{IN} (i.e. Voled_in−Vdata).

Then, in the data-writing phase P1, since only the scan signal Sn is enabled, as shown in FIG. 9B, the writing transistor T3′ and the collection transistor T4′ are turned on (which are not marked by the symbol “X”), and the emission control transistor T2′ and the transformation transistor T5′ are turned off (which are marked by the symbol “X”). In this way, the driving transistor T1′ represents a diode-connection in response to the turn-on state of the collection transistor T4′, so that the storage capacitor Cst is discharged through the driving transistor T1′ and the OLED 601 until the driving transistor T1′ is turned off and the voltage of the node C2 is changed to Voled_th+Vₜₕ(T1). Moreover, in response to the turn-on state of the writing transistor T3′, the voltage of the node B2 is Voled_in−Vdata.

In the present exemplary embodiment, in the data-writing phase P1, the voltage at two ends of the storage capacitor Cst can be represented as:

Voled_in−Vdata−Voled_th−Vₜₕ(T1′).

Moreover, the above expression can be further simplified into −Vdata−ΔVoled−Vₜₕ(T1′), where ΔVoled=Voled_th−Voled_in.

Therefore, in the data-writing phase P1, the data voltage V_{IN}, the threshold voltage Vₜₕ(T1′) related to the driving transistor T1′ and a variation ΔVoled related to the voltage across the OLED 601 are simultaneously and completely stored by the storage capacitor Cst.

Finally, in the emission phase P2, since only the emission signal Em is enabled, as shown in FIG. 9C, the writing transistor T3′ and the collection transistor T4′ are turned off (which are marked by “X”), and the emission control transistor T2′ and the transformation transistor T5′ are turned on (which are not marked by “X”). In this way, the driving transistor T1′ generates the driving current I_{OLED} that is not influenced by the conducting voltage (Voled_th) of the OLED 601 and the threshold voltage Vₜₕ(T1′) of the driving transistor T1′.

In detail, in response to the capacitance coupling effect of the storage capacitor Cst, a gate-source voltage Vgs of the driving transistor T1′ is equal to −Vdata−ΔVoled−Vₜₕ(T1′). In this way, in the emission phase P2, the driving current I_{OLED} generated by the driving transistor T1′ can be represented by a following equation 4:

$${I}_{OLED} = \frac{1}{2} K \times {( Vgs - {V}_{th} ( T {1}^{′} ) )}^{2} , \qquad 4$$

where K is a current constant related to the driving transistor T1′.

In addition, since the gate-source voltage Vgs of the driving transistor T1′ is already known, i.e.: Vgs=-Vdata−ΔVoled−Vₜₕ(T1′), if the known gate-source voltage Vgs of the driving transistor T1′ is introduced to the equation 4, a following equation 5 is obtained:

$${I}_{OLED} = \frac{1}{2} K \times {[ - Vdata - Δ Voled - {V}_{th} ( T {1}^{′} ) + {V}_{th} ( T {1}^{′} ) ]}^{2} ,$$

and the equation 5 can be further simplified into a following equation 6:

$${I}_{OLED} = \frac{1}{2} K \times {( - Vdata - Δ Voled )}^{2} . \qquad 6$$

According to the equation 6, it is known that in the emission phase P2, the driving current I_{OLED} flowing through the OLED 601 is non-related to the threshold voltage Vₜₕ(T1′) of the driving transistor T1′. Moreover, according to the equation 6, it is known that the driving current I_{OLED} flowing through the OLED 601 is determined by Vdata and an additional parameter ΔVoled, where the additional parameter ΔVoled can be used to compensate/mitigate a brightness decay of the OLED 601 in the long time stress. In this way, the driving current I_{OLED} flowing through the OLED 601 is not varied along with a variation of the conducting voltage (Voled_th) of the OLED 601 in the long time stress.

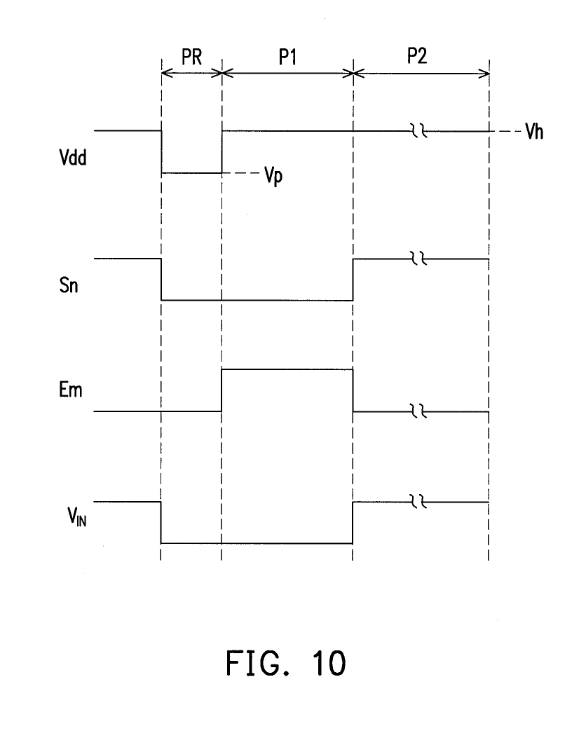

On the other hand, different to the operation waveform diagram of the (OLED) pixel circuit 60 of FIG. 8, FIG. 10 is another operation waveform diagram of the (OLED) pixel circuit 60 of FIG. 6. The operation waveform diagram of the (OLED) pixel circuit 60 of FIG. 8 is constructed based on a situation that the power voltage Vdd is a fixed power voltage, i.e. the power voltage Vdd is maintained to a high level voltage Vh.

However, the operation waveform diagram of the (OLED) pixel circuit 60 of FIG. 10 is constructed based on a situation that the power voltage Vdd is a variable power voltage, and the power voltage Vdd is changed from the high level voltage Vh to a predetermined setting voltage Vp only in the reset phase PR. In other words, besides the reset phase PR, the power voltage Vdd is maintained to the high level voltage Vh, namely, the power voltage Vdd is changed from the setting voltage Vp to the high level voltage Vh in the data-writing phase P1 after the reset phase PR. The setting voltage Vp is lower than the high level voltage Vh, and the setting voltage Vp is determined according to the threshold voltage Vₜₕ(T1′) of the driving transistor T1′ and the conducting voltage (Voled_th) of the OLED 601. In other words, the setting voltage Vp can be a voltage just capable of conducting the OLED 601 and the driving transistor T1′, for example, Voled_th+Vₜₕ(T1′), though the invention is not limited thereto.

A difference between the operation waveform diagrams of the (OLED) pixel circuit 60 of FIG. 8 and FIG. 10 is that as the power voltage Vdd of FIG. 10 can be changed from the high level voltage Vh to the setting voltage Vp in the reset phase PR, the voltage of the node C2 is changed (decreased) to Vp, and the voltage of the node B2 is changed (decreased) to Voled_in−Vdata. However, according to the operation waveform diagram of the (OLED) pixel circuit 60 of FIG. 10, the driving current I_{OLED} flowing through the OLED 601 is still non-related to the threshold voltage Vₜₕ(T1′) of the driving transistor T1′, and meanwhile the brightness decay of the OLED 601 in the long time stress can be compensated/mitigated.

In summary, if the circuit configuration 5T1C (i.e. 5 TFTs+1 capacitor) of the pixel circuit 10/60 of the invention collocates with suitable operation waveforms (shown in FIG. 3 and FIG. 5/FIG. 8 and FIG. 10), the current flowing through the OLED 101/601 is not varied along with the variation of the conducting voltage (Voled_th) of the OLED 101/601 in a long time stress, and is not varied along with the threshold voltage (Vth) shift of the TFT T1/T1′ used for driving the OLED 101/601. Accordingly, not only the brightness decay of the OLED 101/601 in the long time stress can be mitigated or compensated, but also the brightness uniformity of the applied OLED display can be substantially improved. Moreover, any OLED display panel applied with the OLED pixel circuit 10/60 of the aforementioned exemplary embodiments and any OLED display thereof are considered to be within the scope of the invention.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A light-emitting component driving circuit, comprising:
a driving unit, coupled between a preset potential and a light-emitting component, comprising a driving transistor, and configured to control a driving current flowing through the light-emitting component in an emission phase; and
a data storage unit, comprising a storage capacitor directly coupled to a conduction path used for conducting the driving current, and configured to store a data voltage, a threshold voltage related to the driving transistor and a conducting voltage related to the light-emitting component through the storage capacitor in a data-writing phase,
wherein in the emission phase, the driving unit generates the driving current flowing through the light-emitting component in response to a cross-voltage of the storage capacitor, and the driving current is not influenced by the threshold voltage of the driving transistor and the conducting voltage of the light-emitting component.

2. The light-emitting component driving circuit as claimed in claim 1, wherein the preset potential is a ground potential, the light-emitting component is an organic light-emitting diode, and the driving unit further comprises:
an emission control transistor, having a gate receiving an emission signal, a source coupled to the ground potential, and a drain coupled to a source of the driving transistor and a first end of the storage capacitor,
wherein a drain of the driving transistor is coupled to a cathode of the organic light-emitting diode, and an anode of the organic light-emitting diode is coupled to a power voltage.

3. The light-emitting component driving circuit as claimed in claim 2, wherein the data storage unit further comprises:
a writing transistor, having a gate receiving a scan signal, a drain receiving the data voltage, and a source coupled to a second end of the storage capacitor;
a collection transistor, having a gate receiving the scan signal, a source coupled to a gate of the driving transistor, and a drain coupled to the drain of the driving transistor and the cathode of the organic light-emitting diode; and
a transformation transistor, having a gate receiving the emission signal, a source coupled to the gate of the driving transistor and the source of the collection transistor, and a drain coupled to the source of the writing transistor and the second end of the storage capacitor,
wherein the light-emitting component circuit is an organic light-emitting diode driving circuit.

4. The light-emitting component driving circuit as claimed in claim 3, wherein
the organic light-emitting diode driving circuit sequentially operates the data-writing phase and the emission phase;
the driving transistor, the emission control transistor, the writing transistor, the collection transistor and the transformation transistor are all N-type transistors;
in the data-writing phase, only the scan signal is enabled; and
in the emission phase, only the emission signal is enabled.

5. The light-emitting component driving circuit as claimed in claim 4, wherein the power voltage is a fixed power voltage.

6. The light-emitting component driving circuit as claimed in claim 4, wherein the power voltage is a variable power voltage.

7. The light-emitting component driving circuit as claimed in claim 6, wherein
the power voltage is changed from a high level voltage to a setting voltage only in the data-writing phase, and the setting voltage is lower than the high level voltage; and
the setting voltage is determined according to the threshold voltage of the driving transistor and the conducting voltage of the organic light-emitting diode.

8. The light-emitting component driving circuit as claimed in claim 1, wherein the preset potential is a power voltage, the light-emitting component is an organic light-emitting diode, and the driving unit further comprises:
an emission control transistor, having a gate receiving an emission signal, a source coupled to the power voltage, and a drain coupled to a source of the driving transistor and a first end of the storage capacitor,
wherein a drain of the driving transistor is coupled to an anode of the organic light-emitting diode, and a cathode of the organic light-emitting diode is coupled to a ground potential.

9. The light-emitting component driving circuit as claimed in claim 8, wherein the data storage unit further comprising:
a writing transistor, having a gate receiving a scan signal, a source receiving the data voltage, and a drain coupled to a second end of the storage capacitor;
a collection transistor, having a gate receiving the scan signal, a drain coupled to a gate of the driving transistor, and a source coupled to the drain of the driving transistor and the anode of the organic light-emitting diode; and
a transformation transistor, having a gate receiving the emission signal, a drain coupled to the gate of the driving transistor and the drain of the collection transistor, and a source coupled to the drain of the writing transistor and the second end of the storage capacitor,
wherein the light-emitting component circuit is an organic light-emitting diode driving circuit.

10. The light-emitting component driving circuit as claimed in claim 9, wherein the storage capacitor is reset in a reset phase in response to the power voltage and the data voltage.

11. The light-emitting component driving circuit as claimed in claim 10, wherein
the organic light-emitting diode driving circuit sequentially operates the reset phase, the data-writing phase and the emission phase;
the driving transistor, the emission control transistor, the writing transistor, the collection transistor and the transformation transistor are all P-type transistors;
in the reset phase, the scan signal and the emission signal are simultaneously enabled;
in the data-writing phase, only the scan signal is enabled; and
in the emission phase, only the emission signal is enabled.

12. The light-emitting component driving circuit as claimed in claim 11, wherein the power voltage is a fixed power voltage.

13. The light-emitting component driving circuit as claimed in claim 11, wherein the power voltage is a variable power voltage.

14. The light-emitting component driving circuit as claimed in claim 13, wherein
the power voltage is changed from a high level voltage to a setting voltage only in the reset phase, and the setting voltage is lower than the high level voltage; and
the setting voltage is determined according to the threshold voltage of the driving transistor and the conducting voltage of the organic light-emitting diode.

15. A pixel circuit, comprising:
a light-emitting component, lighting in an emission phase in response to a driving current;
a driving unit, coupled between a preset potential and the light-emitting component, comprising a driving transistor, and configured to control the driving current flowing through the light-emitting component in the emission phase; and
a data storage unit, comprising a storage capacitor directly coupled to a conduction path used for conducting the driving current, and configured to store a data voltage, a threshold voltage related to the driving transistor and a conducting voltage related to the light-emitting component through the storage capacitor in a data-writing phase,
wherein in the emission phase, the driving unit generates the driving current flowing through the light-emitting component in response to a cross-voltage of the storage capacitor, and the driving current is not influenced by the threshold voltage of the driving transistor and the conducting voltage of the light-emitting component.

16. The pixel circuit as claimed in claim 15, wherein
the preset potential is a ground potential;
the light-emitting component is an organic light-emitting diode;
the driving unit further comprises:
an emission control transistor, having a gate receiving an emission signal, a source coupled to the ground potential, and a drain coupled to a source of the driving transistor and a first end of the storage capacitor,
wherein a drain of the driving transistor is coupled to a cathode of the organic light-emitting diode, and an anode of the organic light-emitting diode is coupled to a power voltage;
the data storage unit further comprises:
a writing transistor, having a gate receiving a scan signal, a drain receiving the data voltage, and a source coupled to a second end of the storage capacitor;
a collection transistor, having a gate receiving the scan signal, a source coupled to a gate of the driving transistor, and a drain coupled to the drain of the driving transistor and the cathode of the organic light-emitting diode; and
a transformation transistor, having a gate receiving the emission signal, a source coupled to the gate of the driving transistor and the source of the collection transistor, and a drain coupled to the source of the writing transistor and the second end of the storage capacitor; and
the driving transistor, the emission control transistor, the writing transistor, the collection transistor and the transformation transistor are all N-type transistors.

17. The pixel circuit as claimed in claim 15, wherein
the preset potential is a power voltage;
the light-emitting component is an organic light-emitting diode;
the driving unit further comprises:
an emission control transistor, having a gate receiving an emission signal, a source coupled to the power voltage, and a drain coupled to a source of the driving transistor and a first end of the storage capacitor,
wherein a drain of the driving transistor is coupled to an anode of the organic light-emitting diode, and a cathode of the organic light-emitting diode is coupled to a ground potential;
the data storage unit further comprises:
a writing transistor, having a gate receiving a scan signal, a source receiving the data voltage, and a drain coupled to a second end of the storage capacitor;
a collection transistor, having a gate receiving the scan signal, a drain coupled to a gate of the driving transistor, and a source coupled to the drain of the driving transistor and the anode of the organic light-emitting diode; and
a transformation transistor, having a gate receiving the emission signal, a drain coupled to the gate of the driving transistor and the drain of the collection transistor, and a source coupled to the drain of the writing transistor and the second end of the storage capacitor; and
the driving transistor, the emission control transistor, the writing transistor, the collection transistor and the transformation transistor are all P-type transistors.
